(19) United States
(12) Patent Application Publication
(10) Pub. No.: US 2006/0257812 A1
(43) Pub. Date: Nov. 16, 2006

(54) Improvements to an auxiliary element for the segmental distalization to the canine-to-molar posterior maxillary area in orthodontic treatments

(76) Inventor: Luis Carriere Lluch, Barcalona (ES)

Correspondence Address: Michael A O'Neil;Michael A O'Neil PC, 5949 Sherry Lane Suite 820, Dallas, TX, 75225, US

(21) Appl. No.: 10/561,423

(22) PCT Filed: Dec. 15, 2003
(86) PCT No.: PCT/ES03/00631

§ 371 Date: Dec. 19, 2005

(30) Foreign Application Priority Data
Jul. 25, 2003 (ES) 200301758

(51) Int. Cl. A61C 3/00

(52) U.S. Cl. 433/19

(57) ABSTRACT

The improvements are characterised in that the ball joint of the median segment is spherical with two diametrically opposed planar faces in the positions of polar segments of the sphere and the arm of the median segment is joined to the ball joint forming a small acute angle.

The present invention is intended to disclose improvements to the subject of the main patent No. 200102210 for an “Auxiliary element for the segmental distalisation of the canine-to-molar posterior maxillary area in orthodontic treatments”.

The present improvements are the fruit of the experience acquired in the implementation of the main patent and its first application of addition and enable the means required to achieve a better articulation between the median segment and the distal segment to be considerably simplified while allowing the two elements to be connected merely by pressure and allowing free rotation within a large sector of the ball joint within its recess in the distal segment and similarly allowing sufficient play in the lateral rotation and on the axis of the median arm for adjustment of the median segment to the distal segment.

The objectives of the invention are achieved by the formation of the ball joint with a spherical form with two opposed flat polar caps of significant dimensions and with the arm of the median segment inclined at an acute angle to the plane of symmetry of the ball joint. The recess in the distal segment has a form which partially mates with that of the ball joint, with semi-closed edges at the mouth to allow retention of the ball joint merely by pressure within the recess and with a dimension between faces which is somewhat greater than that of the ball joint to allow the lateral play of the median segment at the desired angle.

To assist comprehension, drawings of an embodiment of a distalisation arrangement according to the present invention are attached as non-limiting examples.

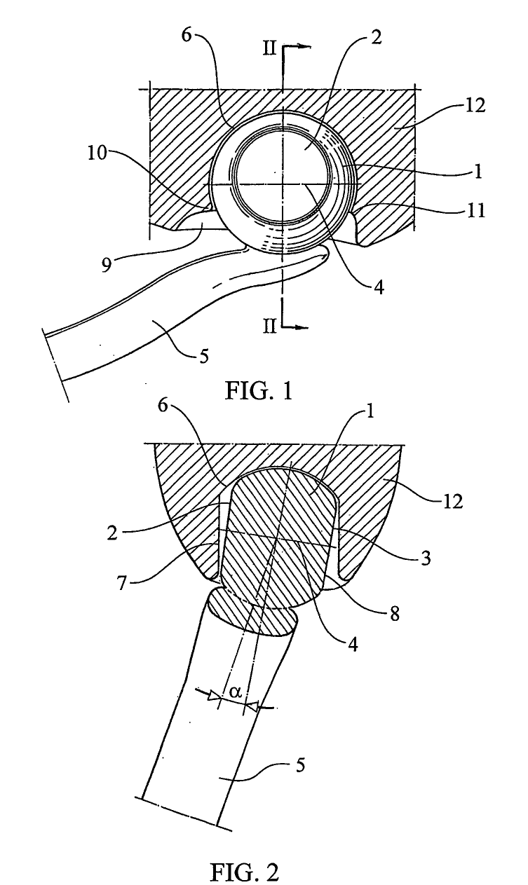

FIG. 1 is a section of a detail of the articulation of the median segment and the distal segment.

FIG. 2 is a section through the indicated sectional plane.

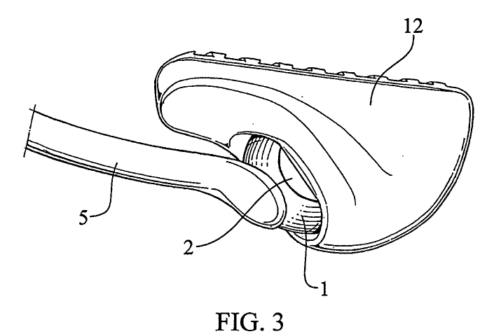

FIG. 3 is a perspective view of the articulation shown in FIGS. 1 and 2.

Referring to the figures, the present invention resides in forming the ball joint 1 with a curved surface shape, preferably as a sphere with diametrically opposed planar polar segments 2 and 3 forming respective planar faces which are perpendicular to a diameter 4 of the spherical surface. The remainder of the surface of the segment is curved, preferably spherical. The median arm 5 may be joined to the ball joint 1, forming a small angle to the plane of symmetry thereof, this angle being indicated by the letter α in FIG. 2.

The recess produced in the distal segment 12 has a shape which substantially mates with a portion of the ball joint, with a lateral surplus which allows lateral play and play with respect to the axis of the median arm for adjustment of the median arm 5. This is illustrated in the figures, which show that the cavity 6 of the distal end has a concave bottom surface of spherical shape with identical sphericity to the ball joint 1 and has parallel lateral faces 7 and 8 which are mutually separated preferably by a distance greater than the width of the ball joint 1, in other words, greater than the distance between the faces 2 and 3 of said ball joint. Said recess 6 also comprises, in its inlet orifice 9, an aperture determined by the edges 10 and 11 which is narrower than the diameter of the ball joint 1 in its spherical portion to allow fitting of the ball joint in the interior of the recess intended therefor by means of a specific pressure which will cause sufficient deformation for the admission of the ball joint and which will not allow the free escape thereof.

The present improvements therefore simplify production of the distalisation element by eliminating the arrangement of transverse axes and allowing easy fitting of the median segment and sufficient rotation thereof for the correct fitting thereof.

Although the invention has been described with reference to the illustrated example, it will be appreciated that it could similarly comprise different variations included within the field of the following claims. Thus, for example, the caps of the ball joint might not be planar, similarly to the lateral faces of the receiving cavity, and the surface of the ball joint might have a non-spherical curved structure. Similarly, the angle α might have a value of zero.

1. Improvements to the subject of the main patent No. 200102210 for an “Auxiliary element for the segmental distalisation of the canine-to-molar posterior maxillary area in orthodontic treatments”, characterised in that the ball joint of the median segment is spherical with two diametrically opposed planar faces in the position of polar segments of the sphere.

2. Improvements to the subject of the main patent No. 200102210 for an “Auxiliary element for the segmental distalisation of the canine-to-molar posterior maxillary area in orthodontic treatments”, according to claim 1, characterised in that the arm of the median segment is joined to the ball joint, forming a small acute angle.

3. Improvements to the subject of the main patent No. 200102210 for an “Auxiliary element for the segmental distalisation of the canine-to-molar posterior maxillary area in orthodontic treatments”, according to claim 1, characterised in that the recess of the distal segment intended to receive the ball joint has a form which partially mates with that of the ball joint, with a width between faces which is somewhat greater than the width between the faces of the ball joint so as to allow the lateral play thereof and play on the axis of the median arm and with a dimension of the inlet orifice of said recess smaller than the diameter of the ball joint so as to allow the ball joint to be pressed in and to prevent the subsequent accidental egress thereof.
